(19) United States
(12) Patent Application Publication
(10) Pub. No.: US 2004/0125953 A1
(43) Pub. Date: Jul. 1, 2004

(54) Broadcasting signal output apparatus and method thereof

(75) Inventors: Eun-Seop Cho, Busan-city (KR); Joo-Yeon Lee, Yongin-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/651,083

(22) Filed: Aug. 29, 2003

(30) Foreign Application Priority Data
Aug. 29, 2002 (KR) 10-2002-0051608

(51) Int. Cl. H04N 7/16; H04N 7/167

(52) U.S. Cl. 380/203; 380/201; 725/25

(57) ABSTRACT

In a broadcasting signal output apparatus and a method, an OSD processing unit produces a display-lock message if a display of contents is not permitted. A control unit determines whether the decoded video signal includes a copy protection signal for preventing the video signal from being reproduced, and if so, the control unit requests and receives a certification signal from the display device to determine whether the video signal can be transmitted to the display device through the video output terminal. The control unit then determines whether the certification signal corresponds with the reproduction preventing signal, and if it does not, prevents the decoded video and audio signal from being outputted, and controls the OSD processing unit so that the display-lock message is output to the display device (e.g., screen), so that the user knows when the currently received broadcasting signal is not displayed due to copy protection signal.

This application claims the priority of Korean Patent Application No. 10-2002-0051608, filed on Aug. 29, 2002, in the Korean Intellectual Property Office, the disclosure of which is incorporated herein in its entirety by reference.

### BACKGROUND OF THE INVENTION

1. Field of the Invention

The present invention relates to a broadcasting signal output apparatus and a method thereof, and more particularly, to a broadcasting signal output apparatus which displays a predetermined message informing that reception broadcasting signal cannot be displayed when viewing of the reception signal is locked based on a copy protection signal, and a method thereof.

2. Description of the Prior Art

In the related art, a digital video signal output from a computer is converted into an analog signal in a graphic card and sent to a monitor. This occurs because a cathode ray tube (CRT) monitor, which is the most generally used type of a monitor, displays an image in analog.

However, in the case of a liquid crystal display (LCD) monitor, the analog signal outputted from the graphic card should be digitized again before being sent to the LCD monitor, since the LCD monitor displays an image in digital format. In the related art, such double data conversion causes video signal data loss.

To prevent the aforementioned data loss, a related art digital video or visual interface (DVI) is adopted. The DVI is a device for digitizing a signal inputted into the DVI and outputting the digitized signal. DVI is used in conjunction with a digital display device, and can transmit a digital signal.

The related art DVI is used not only with a computer, but also with an apparatus for outputting a broadcasting signal such as a set top box (STB), a plasma display panel (PDP), and a DLP projector that converts a received broadcasting signal into a viewable signal and outputs into the digital display device.

Meanwhile, as the digital display device for outputting a high definition image improves, the related art also includes a signal in a broadcasting signal for protecting the contents from unauthorized reproduction or ‘pirates’. Accordingly, when a broadcasting signal including a copy protection signal therein is outputted to the digital display device using the DVI, only a digital display device with a high bandwidth digital protection (HDCP) certification can display the broadcasting signal.

With respect to the digital display device which is not provided with the HDCP, a related art broadcasting output apparatus blocks a broadcasting signal from being output to the digital display device. In such a situation, since the related art broadcasting output apparatus does not transmit informative message such as ‘DISPLAY UNAUTHORIZED’ to the display device, a viewer finds it hard to recognize the current status.

### SUMMARY OF THE INVENTION

An object of the invention is to solve at least the above problems and/or disadvantages and to provide at least the advantages described hereinafter.

Accordingly, one aspect of the present invention is to solve the foregoing problems by providing an apparatus for outputting a broadcasting signal which informs the viewer of the current status when a display device cannot display the broadcasting signal due to a copy protection signal included therein.

A broadcasting signal output apparatus is provided, including a signal decoder for decoding received video and audio signals and outputting the decoded signals, a video output terminal for outputting the decoded video signal to a display device, and an audio output terminal for outputting the decoded audio signal to a speaker. Additionally, an OSD processing unit for producing a display-lock message which informs that a display is not permitted is provided, along with a control unit for, determining whether the decoded video signal includes a copy protection signal for preventing the video signal from being reproduced, and upon determining that the copy protection signal is included, and requesting and receiving a certification signal from the display device to determine whether the video signal can be transmitted to the display device through the video output terminal. The control unit also determines whether the certification signal corresponds with the reproduction preventing signal, upon determining that the certification signal does not correspond with the reproduction preventing signal, prevents the decoded video and audio signal from being output to the video and audio output terminals, and controls the OSD processing unit to so that the display-lock message is output to the display device through the image output terminal.

The video output terminal is a digital video interface which converts an analog signal into digital and outputs the converted signal.

When a certification signal received from the display device and the reproduction preventing signal included in the video signal correspond with each other, the control unit encrypts the decoded video and audio signals and outputting the encrypted video and audio signals respectively to the video output terminal and the audio output terminal.

Further, a method for outputting a broadcasting signal is providing, including a) decoding a received video signal, b) determining whether the decoded video signal includes a copy protection signal for preventing the video signal from being reproduced, and c) when the copy protection signal is included, requesting and receiving a certification signal from a display device to determine whether the decoded video signal can be transmitted to the display device connected with the video output terminal, and determining whether the certification signal corresponds with the reproduction preventing signal. The method also includes d) when the certification signal does not correspond with the reproduction preventing signal, OSD processing and outputting the display-impossible message to the display device.

The video output terminal is a digital video interface which converts an analog signal into digital.

The broadcasting signal output apparatus according to the present invention may also be applied to an apparatus such as a set top box (STB) connected with a monitor and a speaker, a plasma display panel (PDP) and DLP projector which converts received broadcasting signal into digital signal and outputs it.

Additionally, an apparatus for processing a communication signal is provided, including a control unit that generates a channel selection request in response to a user request, a signal decoder that receives and decodes a tuned signal based on the channel selection request, and outputs the decoded signal to said control unit, and a connection detector that detects whether a user terminal has a digital format and outputs a detection result to said control unit. Also, an OSD processor generates a user message when said user terminal has said digital format and a certification of said user terminal does not correspond to a protection signal of said communication signal.

Further, a method for outputting a broadcast signal is provided, including determining whether a communication signal includes a copy protection signal, and when said communication signal includes said copy protection signal, determining whether a digital video interface having a certification is an intended output device for said communication signal. Also, when said digital video interface having said certification is an intended output device for said communication signal, the method determines whether said copy protection signal matches said certification, and when said copy protection signal does not match said certification, generates a message indicating that said communication signal cannot be displayed. Similarly, a computer readable medium containing a set of instructions for outputting a broadcast signal is provided for implementing the foregoing method.

Additionally, an apparatus for processing a communication signal is provided, including a control unit that generates a channel selection request in response to a user request, a signal decoder that receives and decodes a tuned signal based on the channel selection request, and outputs the decoded signal to said control unit, and a connection detector that detects whether a user terminal has a digital format and outputs a detection result to said control unit. Also, an OSD processor generates a user message when said user terminal has said digital format and a certification of said user terminal does not correspond to a protection signal of said communication signal.

Further, a method for outputting a broadcast signal is provided, including determining whether a communication signal includes a copy protection signal, and when said communication signal includes said copy protection signal, determining whether a digital video interface having a certification is an intended output device for said communication signal. Also, when said digital video interface having said certification is an intended output device for said communication signal, the method determines whether said copy protection signal matches said certification, and when said copy protection signal does not match said certification, generates a message indicating that said communication signal cannot be displayed. Similarly, a computer readable medium containing a set of instructions for outputting a broadcast signal is provided for implementing the foregoing method.

### BRIEF DESCRIPTION OF THE DRAWINGS

The above object and the feature of the present invention will be more apparent by describing a preferred embodiment of the present invention with reference to the accompanying drawings, in which:

FIG. 1 is a block diagram showing a broadcasting signal output apparatus according to an exemplary, non-limiting embodiment of the present invention; and

FIG. 2 is a flowchart showing a method for outputting a broadcasting signal according to an exemplary, non-limiting embodiment of the present invention.

### DETAILED DESCRIPTION OF THE PREFERRED EMBODIMENT

Hereinafter, a broadcasting signal output apparatus according to a preferred embodiment of the present invention will be described in greater detail with reference to the accompanying drawings.

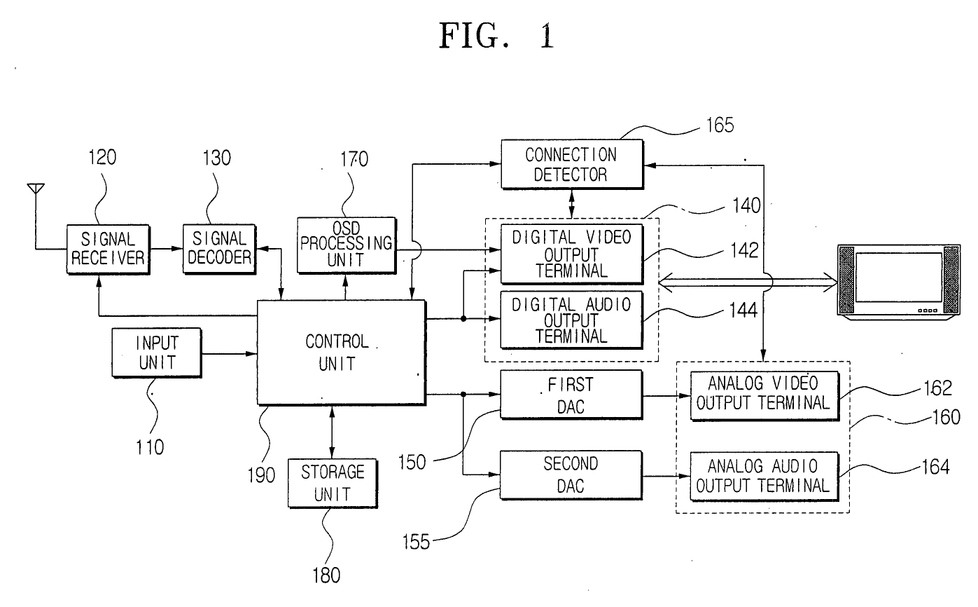

FIG. 1 is a block diagram showing an apparatus for outputting a broadcasting signal according to an exemplary, non-limiting embodiment of the present invention. An input unit 110, a signal receiver 120, a signal decoder 130, a digital output terminal 140, a first digital/analog converter (DAC) 150, a second DAC 155, an analog output terminal 160, a connection detector 165, an OSD processing unit 170, a storage unit 180, and a control unit 190 are provided.

The input unit 110 is provided to a body of the broadcasting signal output apparatus, and comprises a plurality of function keys (not shown) for the operation of the broadcasting signal output apparatus. In general, a user is provided with a remote control unit (not shown) with a plurality of function keys (not shown) to input selection commands for a controlling on the broadcasting signal output apparatus from a remote distance.

The signal receiver 120 receives a digital signal of sky-wave or digital satellite broadcasting from an antenna. In addition, when a channel selection is inputted through the input unit 110 (i.e., a user request is generated as, for example but not by way of limitation, the channel selection input from a user), the signal receiver 120 tunes to a channel corresponding to the selection by the user.

The signal decoder 130 detects video and audio signals from the signals with respect to the channel tuned to by the signal receiver 120, and decodes into a viewable signal. That is, the signal decoder 130 decompresses a compressed broadcasting signal. In the present invention, a decoded broadcasting signal having a property of a digital signal will be taken as an example, but the invention is not limited thereto.

The digital output terminal 140 has a digital video output terminal 142 and a digital audio output terminal 144. The digital video output terminal 142 uses a digital video interface (DVI). The DVI is an interface for transmitting a video signal to a digital display device such as a LCD display device.

The digital audio output terminal 144 transmits a decoded audio signal to a speaker.

For the digital output terminal 140, a high definition multimedia interface (HDMI) may be used, and the digital output terminal 140 can transmit a video signal and an audio signal concurrently to the digital display device and the speaker.

Meanwhile, if the broadcasting output apparatus is connected with an analog display device such as a CRT display device, and if the decoded video signal is a digital video signal, the first DAC 150 converts a digital video signal into an analog video signal, and the second DAC 155 converts a digital audio signal into an analog audio signal.

The analog output terminal 160 has an analog video output terminal 162 and an analog audio output terminal 164. The analog video output terminal 162 and the analog audio output terminal 164 transmits the converted analog video signal and analog audio signal respectively to the analog display device and the speaker.

The connection detector 165 detects an output terminal connected with the display device. That is, the connection detector 165 detects whether the display device is connected with the digital output terminal 140 (i.e., the display device has a digital formal for displaying an output to a user) or with the analog output terminal 160.

When a video signal cannot be transmitted to the digital display device through the digital output terminal 140, the OSD processing unit 170 produces a display-lock message informing that viewing is impossible. This message can be generated as a message to the user (i.e., a user message).

The storage unit 180 stores a control program for controlling the operation and function of the broadcasting signal output apparatus. The control unit 190 controls the overall operation of the broadcasting signal output apparatus. As a non-limiting example, the control unit 190 performs controlling such that the received broadcasting signal is outputted to the digital output terminal 140 or alternatively, to the first DAC 150 or the second DAC 155 according to a detection signal from the connection detector 165.

In addition, when the display device cannot display the received broadcasting signal, the control unit 190 controls the OSD processing unit 170 such that the display-lock message produced in the OSD processing unit 170 is transmitted to the display device through the digital video output display terminal 142.

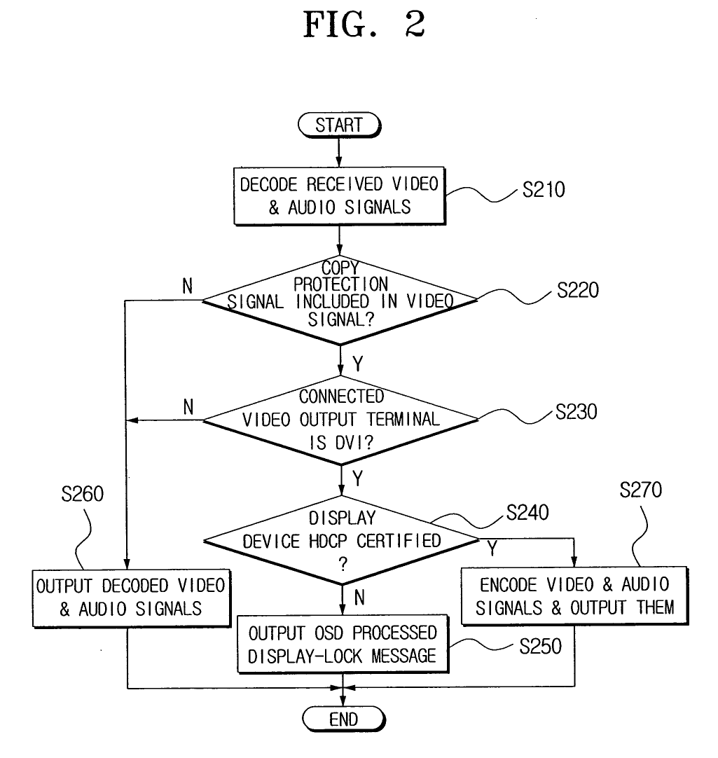

FIG. 2 is a flow chart showing a method for outputting a broadcasting signal according to FIG. 1. The control unit 190 controls the signal decoder 130 so that the received video and audio signal are decoded (S210), in response to a signal received from the input unit 110. Additionally, the control unit 190 determines whether the decoded video signal includes a copy protection signal for preventing the video signal from being reproduced without authorization (S220).

If it is determined that the copy protection signal is included in the step S220, the control unit 190 determines whether a terminal connected with the display device is the digital video output terminal 142 based on a detect signal of the connection detector 165 (S230). That is, in step S230, the control unit 190 determines whether the digital video output terminal 142 is DVI-compliant.

In step S230, if it is determined that the display device is connected with the digital video output terminal 142, the control unit 190 determines whether to transmit the video signal to the display device by requesting and receiving a certification signal to the display device through the digital video output terminal 142 (S240). The certification signal is a signal provided for detecting whether it is permitted to transmit the video signal to the display device connected through the digital video output terminal 142.

If the display device is not provided with the high bandwidth digital content protection (HDCP) certification (i.e., if the certification signal received from the display device and the reproduction preventing signal included in the video signal do not correspond with each other), the control unit 190 prevents the video and audio signal from being outputted to the digital video output terminal 142 and the digital audio output terminal 144. Accordingly, the display device displays a blank screen (e.g., black screen). This occurs at step S250.

In addition, the control unit 190 produces a display-lock message by controlling the OSD processing unit 170, and then transmits the produced display-lock message to the display device through the digital video output terminal 142 (S250).

Meanwhile, if it is determined in the step S220 that the video signal does not include a copy protection signal, the control unit 190 determines which output terminal is connected with the display device and the speaker based on the detect signal of the connection detector 165 and then controls the decoded video and audio signal to be outputted through the output terminal connected with the display device and the speaker (S260).

Additionally, if it is determined that the display device is connected with the analog video output terminal 162 in the step S230, the control unit 190 controls the first and second DACs 150, 155 so that the decoded video and audio signal are converted into analog, and then transmitted to the display device and speaker through the analog output terminal 160 (S260).

If the display device is certified with the HDCP in the step S240 (i.e., if the certification signal received from the display device and the copy protection signal included in the video signal correspond with each other), the control unit 190 encrypts the video and audio signals and transmits them to the display device and speaker, respectively, through the digital video output terminal 142 and the digital audio output terminal 144 (S270).

In the broadcasting signal output apparatus according to the present invention, when transmitting a video signal including a copy protection signal to the digital display device, if the digital display device is not certified with the HDCP, the video signal is prevented from being transmitted and a display-lock message is produced by the OSD processing unit and transmitted to the display device. Accordingly, a user knows what happens when the program is not displayed on the display device due to a copy protection signal.

Additionally, the apparatus and method of present invention may be implemented using a computer readable medium. For example, the computer readable medium may be a disk drive or other storage device containing a set of steps or instructions for implementing the steps of the aforementioned method.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A broadcasting signal output apparatus comprising:
a signal decoder for decoding received video and audio signals and outputting the decoded signals;
a video output terminal for outputting the decoded video signal to a display device;
an audio output terminal for outputting the decoded audio signal to a speaker;
an OSD processing unit for producing a display-lock message which informs that a display is not permitted; and
a control unit for,
determining whether the decoded video signal includes a copy protection signal for preventing the video signal from being reproduced, and upon determining that the copy protection signal is included,
requesting and receiving a certification signal from the display device to determine whether the video signal can be transmitted to the display device through the video output terminal,
determining whether the certification signal corresponds with the reproduction preventing signal,
upon determining that the certification signal does not correspond with the reproduction preventing signal, preventing the decoded video and audio signal from being output to the video and audio output terminals, and
controlling the OSD processing unit to so that the display-lock message is output to the display device through the image output terminal.

2. The apparatus according to claim 1, wherein the video output terminal is a digital video interface that converts an analog signal into a digital signal and outputs the converted digital signal.

3. The apparatus according to claim 1, wherein when a certification signal received from the display device corresponds with the reproduction preventing signal included in the video signal, the control unit encrypts the decoded video and audio signals and outputs the encrypted video and audio signals respectively to the video output terminal and the audio output terminal.

4. A method for outputting a broadcasting signal comprising:
a) decoding a received video signal;
b) determining whether the decoded video signal includes a copy protection signal for preventing the video signal from being reproduced;
c) when the copy protection signal is included, requesting and receiving a certification signal from a display device to determine whether the decoded video signal can be transmitted to the display device connected with the video output terminal, and determining whether the certification signal corresponds with the reproduction preventing signal; and
d) when the certification signal does not correspond with the reproduction preventing signal, OSD processing and outputting the display-impossible message to the display device.

5. The method for outputting a broadcasting signal according to claim 4, wherein the video output terminal is a digital video interface that converts an analog signal into digital.

6. An apparatus for processing a communication signal, comprising:
a control unit that generates a channel selection request in response to a user request;
a signal decoder that receives and decodes a tuned signal based on the channel selection request, and outputs the decoded signal to said control unit;
a connection detector that detects whether a user terminal has a digital format and outputs a detection result to said control unit; and
an OSD processor that generates a user message when said user terminal has said digital format and a certification of said user terminal does not correspond to a protection signal of said communication signal.

7. The apparatus of claim 6, further comprising:
a digital output processor that receives and decrypts said communication signal from said control unit, and transmits said communication to said user terminal when said user terminal has said digital format; and
an analog output processor that receives and decrypts said communication signal from said control unit, converts said decrypted communication signal to an analog signal, and transmits said analog signal to said user terminal when said user terminal does not have said digital format.

8. The apparatus of claim 6, wherein said user request is generated by an input unit that is one of remote and position in said control unit.

9. The apparatus of claim 6, wherein said user terminal having said digital format uses a digital video interface.

10. The apparatus of claim 6, wherein said user terminal having said digital format uses a high definition multimedia interface.

11. A method for outputting a broadcast signal, comprising:
determining whether a communication signal includes a copy protection signal;
when said communication signal includes said copy protection signal, determining whether a digital video interface having a certification is an intended output device for said communication signal;
when said digital video interface having said certification is an intended output device for said communication signal, determining whether said copy protection signal matches said certification; and
when said copy protection signal does not match said certification, generating a message indicating that said communication signal cannot be displayed.

12. The method of claim 11, further comprising:
when said copy protection signal matches said certification, encoding and outputting said communication signal to said digital video interface.

13. The method of claim 11, further comprising:
when one of (a) said communication signal does not include said copy protection signal and (b) said digital video interface having said certification is not an intended output device for said communication signal, processing outputting said communication signal to a user terminal.

14. The method of claim 13, said processing and outputting comprising:
receiving and decrypting said communication signal, and transmitting said communication to said user terminal when said user terminal has said digital format; and
receiving and decrypting said communication signal, converting said decrypted communication signal to an analog signal, and transmitting said analog signal to said user terminal when said user terminal does not have said digital format.

15. The method of claim 11, further comprising:
generating a user request via an input unit to request said communication signal on a channel; and
receiving and decoding said communication signal via a signal decoder.

16. A computer readable medium containing a set of instructions for outputting a broadcast signal, said instructions comprising:
determining whether a communication signal includes a copy protection signal;
when said communication signal includes said copy protection signal, determining whether a digital video interface having a certification is an intended output device for said communication signal;
when said digital video interface having said certification is an intended output device for said communication signal, determining whether said copy protection signal matches said certification; and
when said copy protection signal does not match said certification, generating a message indicating that said communication signal cannot be displayed.

17. The computer readable medium of claim 16, further comprising:
when said copy protection signal matches said certification, encoding and outputting said communication signal to said digital video interface.

18. The computer readable medium of claim 16, further comprising:
when one of (a) said communication signal does not include said copy protection signal and (b) said digital video interface having said certification is not an intended output device for said communication signal, processing outputting said communication signal to a user terminal.

19. The computer readable medium of claim 18, said processing and outputting comprising:
receiving and decrypting said communication signal, and transmitting said communication to said user terminal when said user terminal has said digital format; and
receiving and decrypting said communication signal, converting said decrypted communication signal to an analog signal, and transmitting said analog signal to said user terminal when said user terminal does not have said digital format.

20. The computer readable medium of claim 16, further comprising:
generating a user request via an input unit to request said communication signal on a channel; and
receiving and decoding said communication signal via a signal decoder.
